(19) United States
(12) Patent Application Publication
(10) Pub. No.: US 2007/0118877 A1
(43) Pub. Date: May 24, 2007

(54) Method and system for secured online collaboration

(76) Inventor: Yucel Karabulut, Karlsruhe (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/287,007

(22) Filed: Nov. 22, 2005

(51) Int. Cl. H04L 9/32

(52) U.S. Cl. 726/3

(57) ABSTRACT

A method and system for providing secured collaboration for participants from different security domains in a workflow management system are provided. In one embodiment of the invention, the system comprises a portal server receiving a request from the participants to access a resource server, the resource server communicatively coupled to the portal server and one or more trusted authorities for establishing certified authorization roles of the participants, wherein the portal server and the resource server determine an access specification for verifying if the certified authorization roles correspond to the access specification, so as to provide access to one or more applications hosted at the resource server.

### FIELD OF THE INVENTION

An embodiment relates generally to the field of online collaboration. More particularly, an embodiment relates to a method and a system for secured collaboration wherein the participants are from different security domains.

### BACKGROUND OF THE INVENTION

The Internet and the World Wide Web (“Web”) have changed the landscape of information delivery and affected numerous aspects of life. One benefit of this technological development is the ability to conduct business transactions globally via the Internet. As the volume of commerce conducted over the Internet continues to increase, collections of business units or organizations are working together to pool resources and expertise in order to achieve a common business objective. Organizations are sharing services and resources across enterprise boundaries in order to undertake collaborative projects that they could not undertake individually, or to offer composed services that could not be provided by individual organizations.

A growing array of technologies has emerged to help bridge the gaps between people, time and geography in such collaborative environments. These include both synchronous and a synchronous technologies such as email, web conferencing and instant messaging. These technologies often include the ability to display and share application files. Presentations, spreadsheets and documents are shared among participants without requiring the participants to have these files individually installed on their system.

However, such online collaboration is threatened by security issues such as data eavesdropping, data tampering and entity repudiation. Often, customer information and financial account numbers are stolen through data eavesdropping, whereby data remains intact but privacy is compromised. In a data-tampering event, the data is altered or replaced in a transaction. For example, someone can change the amount to be transferred to and from a bank account. In entity repudiation, the identity of the participant is compromised. Often, data is passed to a person posing as the intended recipient.

In addition, the collaborative system is collectively made up of systems provided by different organizations. For example, an organization may contribute a portal system while another organization presents a financial database system. These systems are of different trust and security domains. Consequently, the security requirements and management are more complex.

Many security and trust management technologies have been developed to address the demand for secured online collaboration. One common security approach is static management of the collaborative system whereby an administrator manually and explicitly defines how content is grouped together and the access control to the content. However, this approach assumes that the users are registered in advance, which is seldom the case in dynamic collaborative environments. Moreover, in such environments, the roles of the users are frequently changing and therefore, the access control to the content is dynamic. Improvements in secured online collaboration are certainly needed.

### SUMMARY OF THE INVENTION

According to one aspect of the present invention, there is provided a method and system for providing secured collaboration for participants from different security domains. In one embodiment of the invention, the system comprises a portal server receiving a request from the participants to access a resource server, the resource server being communicatively coupled to the portal server and one or more trusted authorities for establishing certified authorization roles of the participants, and wherein the portal server and the resource server establish an access specification for verifying if the certified authorization roles correspond to the access specification so as to provide access to one or more applications hosted at the resource server. Upon establishing the certified authorization roles of the participants, the trusted authorities generate a role certificate encoded with the information of the participants and the certified authorization roles.

The portal server receives the role certificate from the participants and determines the authenticity of the role certificate using public key cryptography. In addition, the portal server extracts the certified authorization roles from the role certificate and determines if the certified authorization roles correspond to the access specification. In response to a successful verification, the portal server generates an encrypted digital certificate and encodes the role certificate in the encrypted digital certificate. The encrypted digital certificate is subsequently submitted to the resource server.

The resource server uses public key cryptography to determine if the encrypted digital certificate is provided by the portal server, extracts the role certificate from the encrypted digital certificate and authorizes access to the one or more applications by comparing the certified authorization roles in the role certificate with the access specification. The resource server encrypts the content of the one or more applications and submits the encrypted content of the one or more applications to the portal server. The portal server forwards the encrypted content of the one or more applications to the participants for decryption.

Other features of the present invention will be apparent from the accompanying drawings and from the detailed description that follows.

### BRIEF DESCRIPTION OF THE DRAWINGS

An embodiment of the present invention is illustrated by way of example and not limitation in the figures of the accompanying drawings, in which like references indicate similar elements and in which:

FIG. 1 is a network diagram depicting a system for delegating authority to a participant for accessing collaborative resources in accordance with one exemplary embodiment of the present invention;

FIG. 2 is a flowchart illustrating a method to delegate authority for accessing collaborative resources according to one exemplary embodiment of the present invention; and

FIG. 3 is an interactive flow chart illustrating a method to delegate authority for accessing collaborative resources according to one exemplary embodiment of the present invention.

### DETAILED DESCRIPTION

A method and system for secured on-line collaboration with participants from different security domains are described. In the following description, for purposes of explanation, numerous specific details are set forth in order to provide a thorough understanding of an embodiment of the present invention. It will be evident, however, to one skilled in the art that the present invention may be practiced without these specific details.

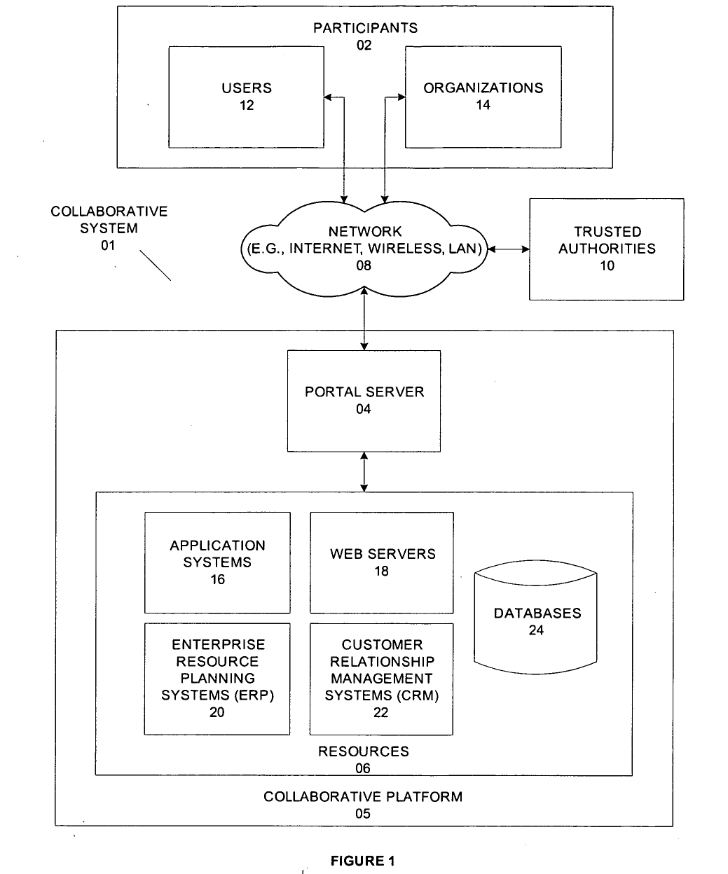

FIG. 1 is a network diagram depicting a collaborative system 01, according to one exemplary embodiment of the invention. A collaborative platform 05 provides collaborative resources 06, via a portal server 04 connected to the network 08 (e.g., Internet, wireless, LAN) to one or more participants 02, such as users 12 and organizations 14.

In one embodiment of the invention, the collaborative platform 05 includes a portal server 04 and resources 06. The portal server 04 provides access to the resources 06, which includes application systems 16, web servers 18, enterprise resource planning systems (ERP) 20, customer relationship management systems (CRM) 22 and databases 24. It will be noted that in a collaborative on-line environment, the systems (16, 18, 20, 22 and 24) may be provided by different participants 02 or trusted authorities 10. Stated differently, each of the systems (16, 18, 20, 22 and 24) of the collaborative resources 06 are independently managed by one or more participants 02 or trusted authorities 10. Consequently, each of the systems (16, 18, 20, 22 and 24) may belong to different security domains.

The portal server 04 is designed to provide secured access to each of the systems (16, 18, 20, 22 and 24) of the resources 06. Stated differently, the portal server 04 allows organizations to expose their resources to partners, suppliers and customers while maintaining confidentiality for restricted information. For example, the portal server 04 may allow a product supplier to access the ERP systems 20 but not the databases 24 which only a partner has an access. In addition, the portal server 04 may restrict the product supplier to access only certain contents of the ERP systems 20. Therefore, the portal server 04 provides customized and personalized treatment for each of the participants 02.

For the participants 02 to access the collaboration platform 05, the participants 02 submit a role certificate to the collaboration platform 05. The role certificate represents that the participants 02 has the required role to perform a particular task. The role certificate is issued or/and certified by the trusted authorities 10, such as government boards, regulatory bodies, financial or engineering institutes, private or public review communities. Alternatively, the trusted authorities 10 are members of the participants 02 who have been authorized to verify the credentials of the other participants 02. For example, the organizations 14 may verify the credentials of the users 12, whereby the users 12 are employees or partners of the organizations 14.

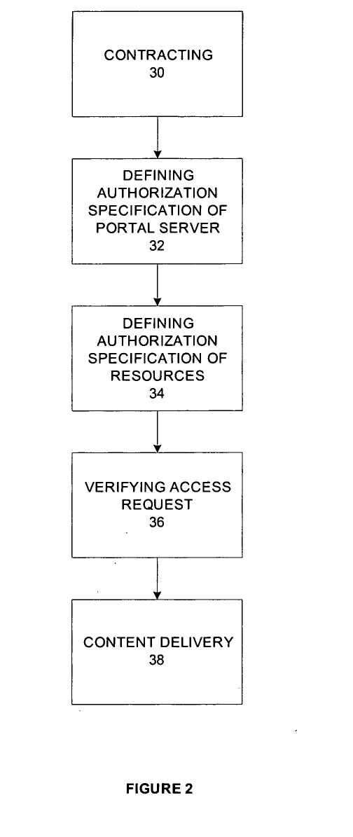

Some of these trusted authorities 10 may be generally referred to as certification authority (CA). The primary role of the CA is to verify the credentials of the participants 02 requesting the role certificate and to issue the certificate upon confirming the credentials. For example, a shipping company submits its credentials to the CA. The CA proceeds to verify the credentials of the shipping company and upon confirming the credentials, the CA provides the shipping company with the role certificate which asserts that the shipping company can perform delivery services locally and internationally. The role certificate enables the shipping company to securely access the resources 06 of the collaboration platform 05. The method of providing security access to the resources 06 via the portal server 04 using the role certificate is further described below with reference to FIG. 2.

While FIG. 1 shows the systems (04, 16, 18, 20, 22 and 24) of the collaborative platform 05 being centrally located at a network segment, a distributed network system may be implemented. In addition, the two or more of the systems (04, 16, 18, 20, 22 and 24) may be combined into a single system or a single system may be divided into multiple systems.

FIG. 2 is a flowchart illustrating a method to delegate authority for accessing collaborative resources according to one exemplary embodiment of the present invention. The process begins at block 30 with the contracting phase. In this contracting phase, the portal server 04 and the participants 02 establish an agreement of the authorized roles that may have access to the resources 06 via the portal server 04. Stated differently, the portal server 04 will accept the authorized roles stated in the agreement as valid, if a member of the participants 02 can prove that he owns a valid role certificate issued by the participants 02. In addition, the agreement is made available to the systems (16, 28, 20, 22 and 24) of the resources 06.

In the second phase, block 32, the authorization specifications for the portal server 04 is defined. The authorization specifications for the portal server 04 express which portal content (view pages) are allowed to be accessed by which roles. In one embodiment of the invention, the authorization specification for the portal server 04 is determined by the role certificate of the participants 02. Stated differently, the invention enables content structure and the content of the portal server 04 to be highly customized according to the certified authorization roles of the participants 02. In one embodiment of the invention, the portal server 04 associates each view page presented to the participants 02 and/or each of the components of the view page with the authorization specification. The view pages and each of the components is associated with the authorization role as specified. When the participants 02 access the content, the view pages and the components are filtered according to the authorization role. If the participants 02 are permitted to access a view page or a component of the view page, the portal server 04 consults the authorization specification which further defines the actions and operations the participants 02 can performed. It is noted that the authorization specification for the portal server 04 may be defined during or prior to the runtime of the collaboration process.

Turning back to FIG. 2, the authorization specification for the resources 06 is defined in block 34. In particular, the administrators of systems (16, 18, 20, 22 and 24) determine the access right of the participants 02 based on the authorized roles. It will be noted that these systems (16, 18, 20, 22 and 24) are provided by participants 02 from different security domains. Therefore, the invention enables the administrators to independently manage the systems (16, 18, 20, 22 and 24) without compromising the overall security of the collaboration platform 01.

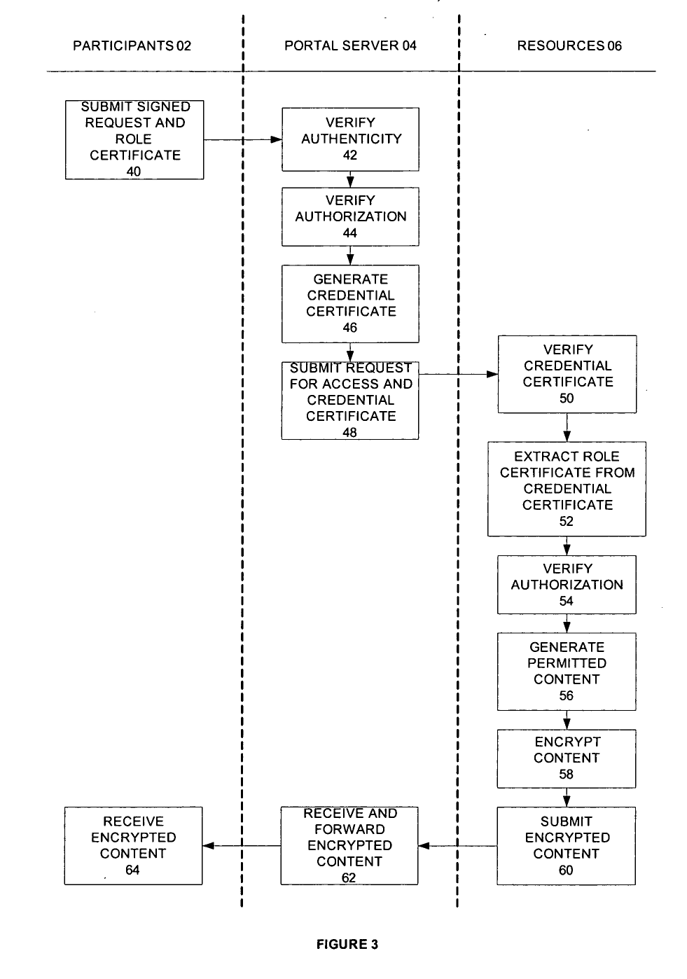

Once the authorization specification has been specified for the portal server 04 and the resources 06 (block 34 and 36), the participants 02 can submit request to access the systems (16, 18, 20, 22 and 24) at block 36. The process of authorizing access request 36 is further elaborated below with reference to FIG. 3. The process is completed when the access request is accepted and the content is delivered to the participants 02 at step 38.

FIG. 3 is an interactive flow chart illustrating a method for authorizing access request to the resources 06. The process begins at block 40 whereby the participants 02 submit a request to access the resources 06 via the portal server 04. In one embodiment of the invention, the participants 02 digitally sign the request by using a private key based on techniques from the field of public-key cryptography. In addition, the participants 02 submit to the portal server 04 the role certificate as described above.

In response to the request from the participants 02, the portal server 04 verifies the authenticity (block 42) and the authorization (block 44) of the request. The proof of authenticity is based on the digital signature of the request. That is, the portal server 04 verifies the digital signature by using the public key contained in the digital signature certificate issued by the CA. Once the authenticity of the request has been confirmed, the portal server verifies the authorization (block 44). In one embodiment, the portal server 04 extracts the certified authorization roles of the participants 02 from the role certificate. Based on the certified authorization roles, the portal server 04 determines the view pages of the portal server 04 accessible by the participants based on the authorization specification of the portal server 04 which is defined earlier (FIG. 2, block 32). In response to a positive authorization, the portal server 04 proceeds to request access to the resources 06 by preparing a credential certificate (block 46). The credential certificate contains the public key of the portal server 04, the public key of the resources 06, the role certificate of the participants 02, a time period of the validity of the credential certificate and the digital signature of the portal server. The portal server 04 submits the request for access and the credential certificate 48 to the resources 06 at block 48.

The resources 06 proceed to verify the credential certificate at block 50. In particular, the resources 06 determine that the credential certificate is indeed issued by a trusted portal server 04. In one example, the resources 06 apply public-key cryptography against digital signature of the portal server 04 to verify the identity of the portal server 04. Next, the resources 06 extract the role certificate of the participants 02 from the credential certificate at block 52. The resources 06 further apply the credential certificate against the authorization specification for the resources 06 (FIG. 2, block 34). Based on the certified authorization roles encoded in the role certificate, the resources 06 is able to determine the set of information or objects permitted to be accessed by the participants 02. It will be noted that the authenticity of the role certificate has already been verified by the portal server 04, and hence, it is unnecessary for the resources 06 to re-verify the role certificate. The permitted content is generated (block 56) and further encrypted (block 58) before being submitted to the portal server 04 (block 60). The portal server 06 receives the permitted content and forwards the content to the participants 02 at block 62. The participants 02 receive the content (block 64) and can browse the content after decrypting the content. Although not illustrated, alternatively, the resources 06 may return the permitted content to the clients 02 directly.

Thus, a method and system for secured on-line collaboration with participants from different security domains are described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A computer-implemented method for providing secured collaboration for participants of different security domains in a workflow management system, the method comprising:
establishing certified authorization roles of the participants;
determining an access specification for accessing the workflow management system; and
verifying if the certified authorization roles of the participants correspond to the access specification, so as to provide an access to the workflow management system.

2. The method of claim 1, wherein establishing certified authorization roles of the participants comprises providing information of the participants to one or more trusted authorities for verification.

3. The method of claim 2, further comprising the one or more trusted authorities providing a role certificate, the role certificate encoded with the information and the certified authorization roles of the participants.

4. The method of claim 2, wherein the information of the participants relate to qualifications of the participants.

5. The method of claim 3, wherein determining the access specification for accessing the workflow management system comprises associating the certified authorized roles with a right to access to one or more portal applications and resource applications of the workflow management system.

6. The method of claim 5, wherein the portal applications determine content of the resource applications and layout of the content to be presented to the participants.

7. The method of claim 3, wherein verifying if the certified authorization roles of the participants correspond to the access specification comprises determining authenticity of the role certificate and determining authorization of the participants.

8. The method of claim 7, wherein determining the authenticity of the role certificate comprises using public key cryptography to confirm if the role certificate is provided by the one or more trusted authorities.

9. The method of claim 7, wherein determining the authorization of the participants comprises extracting the certified authorization roles from the role certificate and confirm if the certified authorization roles matches the access specification.

10. The method of claim 9, further comprising generating an encrypted digital certificate and encoding the role certificate in the encrypted digital certificate, in response to a positive verification of the authorization of the participants.

11. The method of claim 10, further comprising submitting the encrypted digital certificate to the resource applications.

12. The method of claim 11, further comprising, at the resource applications, using public key cryptography to determine if the encrypted digital certificate is provided by the portal applications; extracting the role certificate from the encrypted digital certificate; and authorizing the access to the resource applications by comparing the certified authorization roles in the role certificate with the access specification.

13. The method of claim 12, further comprising encrypting the content of the resource applications and submitting the encrypted content of the resource applications to the portal applications.

14. The method of claim 13, further comprising the portal applications forwarding the encrypted content of the resource applications to the participants for decryption.

15. A system for providing secured collaboration for participants of different security domains, the system comprising:
a portal server receiving a request from the participants to access a resource server, the resource server communicatively coupled to the portal server; and
one or more trusted authorities for establishing certified authorization roles of the participants,
wherein the portal server and the resource server determine an access specification for verifying if the certified authorization roles correspond to the access specification, so as to provide an access to one or more applications hosted at the resource server.

16. The system of claim 15, wherein the one or more trusted authorities for establishing certified authorization roles of the participants comprises receiving qualification information from the participants and verifying the qualification information.

17. The system of claim 16, further comprising the one or more trusted authorities encoding the qualification information and the certified authorization roles in a role certificate.

18. The system of claim 17, wherein the portal server for verifying the participants comprises receiving the role certificate from the participants and determining the authenticity of the role certificate using public key cryptography.

19. The system of claim 18, further comprising the portal server extracting the certified authorization roles from the role certificate and determining if the certified authorization roles correspond to the access specification.

20. The system of claim 19, further comprising the portal server generating an encrypted digital certificate and encoding the role certificate in the encrypted digital certificate, in response to the certified authorization roles corresponding to the access specification.

21. The system of claim 20, further comprising the portal server submitting the encrypted digital certificate to the resource server.

22. The system of claim 21, further comprising the resource server using public key cryptography to determine if the encrypted digital certificate is provided by the portal server; extracting the role certificate from the encrypted digital certificate; and authorizing the access to the one or more applications by comparing the certified authorization roles in the role certificate with the access specification.

23. The system of claim 22, further comprising the resource server encrypting the content of the one or more applications and submitting the encrypted content of the one or more application to the portal server.

24. The system of claim 23, further comprising the portal server forwarding the encrypted content of the one or more applications to the participants for decryption.

25. A machine-readable medium comprising instructions, which when executed by a machine, cause the machine to perform a method for providing secured collaboration for participants of different security domains in a workflow management system, the method comprising:
establishing certified authorization roles of the participants;
determining an access specification for accessing the workflow management system; and
verifying if the certified authorization roles of the participants correspond to the access specification, so as to provide an access to the workflow management system.

26. The machine-readable medium of claim 25, wherein establishing certified authorization roles of the participants comprises providing information of the participants to one or more trusted authorities for verification.

27. The machine-readable medium of claim 26, further comprising the one or more trusted authorities providing a role certificate, the role certificate encoded with the information and the certified authorization roles.

28. The machine-readable medium of claim 26, wherein the information of the participants relate to qualifications of the participants.

29. The machine-readable medium of claim 27, wherein determining the access specification for accessing the workflow management system comprises associating the certified authorized roles with a right to access to one or more accessing portal applications and resource applications of the workflow management system.

30. The machine-readable medium of claim 29, wherein the portal applications determine content of the resource applications and layout of the content to be presented to the participants.

31. The machine-readable medium of claim 27, wherein verifying if the certified authorization roles of the participants correspond to the access specification comprises determining authenticity of the role certificate and determining authorization of the participants.

32. The machine-readable medium of claim 31, wherein determining the authenticity of the role certificate comprises using public key cryptography to confirm if the role certificate is provided by the one or more trusted authorities.

33. The machine-readable medium of claim 31, wherein determining the authorization of the participants comprises extracting the, certified authorization roles from the role certificate and confirm if the certified authorization roles matches the access specification.

34. The machine-readable medium of claim 33, further comprising generating an encrypted digital certificate and encoding the role certificate in the encrypted digital certificate, in response to a positive verification of the authorization of the participants.

35. The machine-readable medium of claim 34, further comprising submitting the encrypted digital certificate to the resource applications.

36. The machine-readable medium of claim 35, further comprising, at the resource applications, using public key cryptography to determine if the encrypted digital certificate is provided by the portal applications; extracting the role certificate from the encrypted digital certificate; and determining the access to the resource applications by comparing the certified authorization roles in the role certificate with the access specification.

37. The machine-readable medium of claim 36, further comprising encrypting the content of the resource applications and submitting the encrypted content of the resource applications to the portal applications.

38. The machine-readable medium of claim 37, further comprising the portal applications forwarding the encrypted content of the resource applications to the participants for decryption.
